(19) United States
(12) Patent Application Publication
(10) Pub. No.: US 2009/0327799 A1
(43) Pub. Date: Dec. 31, 2009

(54) COMPUTER READABLE MEDIUM, SERVER MANAGEMENT METHOD AND DEVICE

(75) Inventors: Hiroshi Yazawa, Kawasaki (JP); Shigehiro Yoshikawa, Kawasaki (JP); Satoshi Iyoda, Kawasaki (JP); Yoshinobu Hibi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/553,696

(22) Filed: Sep. 3, 2009

Related U.S. Application Data
(63) Continuation of application No. PCT/JP2007/056985, filed on Mar. 29, 2007.

(51) Int. Cl. G06F 11/20; G06F 15/177

(52) U.S. Cl. 714/4; 709/220; 714/E11.071; 713/2

(57) ABSTRACT

A management server is equipped with a manager comprising software including a server management program. A managed server has a built-in system disk capable of being booted, on which an agent is installed that is software for communicating with the manager of the management server to monitor the state of the managed server. When a part other than the disk is failed, the system disk is removed from the managed server and attached to a preliminary server. The manager updated the content in a server management table for managing the information of the managed server, thereby eliminating mismatches of network addresses and the like.

### CROSS-REFERENCE TO RELATED APPLICATION

This application is based upon and claims the benefit of priority of the prior international Patent Application No. PCT/JP2007/056985, filed on 29 Mar. 2007, the entire contents of which are incorporated herein by reference.

### FIELD

The present invention relates generally to a computer readable medium storing a server management program executed on a management server which manages a management target server, a server management method and a server management device, and more particularly to a program etc for automatically updating, on the occasion of transfer of a built-in system disk to a standby server when a fault occurs in the management target server, an associated piece of identifying information and getting the standby server to continue an operation as a new management target server.

### BACKGROUND ART

A method has hitherto been adopted, by which a standby server device, for coping with a case where a fault occurs in the server device, is installed while removing the failed server device, and system data backed up before hand is restored (copied) to the built-in disk of the standby server.

The method described above is, however, required to back up the system previously in preparation against the fault, and it is time-consuming to back up the data. Further, timing when backing up the system depends on judgment of an administrator, and hence, if not frequently backed up, the data in the system after being restored become old. Moreover, it is also time-consuming to execute a copying process for restoring the data.

Thus, there is a demand for attaining a recovery by transferring a disk in the case that a fault of the server device occurs in a component (which is, e.g., a motherboard) other than the disk, and that the system can be recovered by transferring the disk of the failed server device to the standby server device.

For example, Patent document 1 discloses a technology, for replacing an in-operation magnetic disk, that disconnection and connection of a connection line from and to a communication path are controllable from a control device, and that the disk is transferred after temporarily interrupting communications.

[Patent Document 1] Japanese Patent Laid-Open Publication No. H11-353129

Patent document 1 given above does not, however, disclose a point of manipulating information managed by the standby server device on the occasion of reinserting the disk of the failed server device into the standby server device and thus operating the standby server device. If the server device is managed by a management server computer on a network, even when reinserting the disk of the failed server device into the standby server device and thus starting up the standby server device, a MAC address etc of the new server device is not registered, and therefore such a problem arises that mismatching is caused.

It is an object (solution) of the present invention, which was devised in view of the problems inherent in the prior art described above, to provide a server management program capable of obviating the mismatching of a network address etc on the occasion of reinserting a disk of a failed server device into a standby server device.

### SUMMARY

A server management program according to the present invention makes a management server computer, which manages a management target server having a built-in system disk with which the server can be booted and a standby server disposed as a substitute device for the management target server via a network, function as: server identifying information writing device instructing the management target server to write server identifying information to the system disk of the management target server; server registering device registering the server identifying information in the server management table in a way that associates the server identifying information with interface identifying information, transmitted from the management target server, for identifying an interface unit of the management target server for a connection with a network; identifying information acquiring device acquiring, after an administrator has started up a standby server by reinserting a system disk of the management target server into the standby server, the server identifying information and the interface identifying information transmitted from the standby server; extracting device extracting from records registered in the server management table, are cord in which the server identifying information is coincident with the server identifying information acquired by the identifying information acquiring device; and rewriting device of rewriting a value of the interface identifying information in the record, extracted by the extracting device, in the server management table with a value of the interface identifying information acquired by the identifying information acquiring device.

Further, it is desirable that the server registering device registers the information including an operating status of the management target server in the server management table, and updates the operating status based on the information given from the management target server, and the extracting device, when the operating status in the record containing the server identifying information coincident with that acquired by the identifying information acquiring device is not “normal”, extracts this record.

Still further, the server management program may further make the management server computer function as recovery method presenting device searching through, if a fault occurs in the management target server, a fault component recovery associating table in which a fault component and a recovery method are previously registered in the way of being associated with each other on the basis of information on the fault component that is sent from the management target server, and presenting the recovery method associated with the fault component to the administrator.

It should be noted that a server management method according to the present invention corresponds to steps for making the computer execute the program, and a server management device according to the present invention is equivalent to the computer functioning in this way.

### EFFECT OF THE INVENTION

According to the present invention, if the fault occurs in a component other than the disk of the server device, the disk has been used till the occurrence of the fault can be utilized in the way of its being reinserted into the standby server device to thereby enable the standby server device to be surely started up and enable the system to be restored in an updated status. Moreover, a necessity for backing up the data and executing a process of copying a file when restored is eliminated, and hence the operation time can be reduced.

### BRIEF DESCRIPTION OF THE DRAWINGS

FIG. 1 is a block diagram conceptually illustrating an architecture of a computer system including a management server device into which a server management program is installed in an embodiment, and also illustrating a status before a disk is transferred.

FIG. 2 is a block diagram conceptually illustrating the architecture of the computer system including the management server device into which the server management program is installed in the embodiment, and also illustrating a status after the disk has been transferred.

FIG. 3 is a flowchart illustrating details of a predefinition process of the server management program according to the embodiment of the present invention.

FIG. 4 is a flowchart illustrating details of a replacement process due to a fault of the server management program according to the embodiment of the present invention.

FIG. 5 is a flowchart illustrating details of an updating process, invoked in step S103 in FIG. 4, for updating a server management table due to a fault of a management target server.

FIG. 6 is a flowchart illustrating details of a specifying process, invoked in step S104 in FIG. 4, for specifying a server recovery method.

FIG. 7 is a flowchart illustrating details of an updating, invoked in step S108 in FIG. 4, for updating the server management table when the server is started up.

FIG. 8 is a flowchart illustrating details of a switch control process invoked in steps S407, S419 in FIG. 7.

FIG. 9 is a flowchart illustrating details of a server management table rewriting process invoked in steps S407, S419 in FIG. 7.

FIG. 10 is a flowchart illustrating details of a recovery process of the server taking a mismatching status in the server management program according to the embodiment of the present invention.

### DESCRIPTION OF EMBODIMENTS

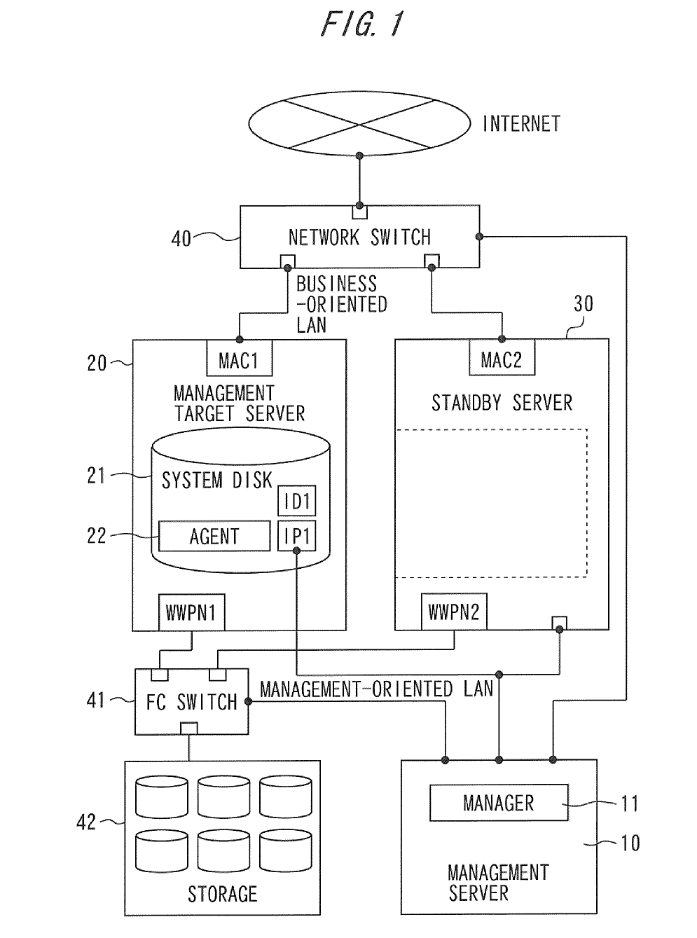

An embodiment of a server management program according to the present invention will hereinafter be described. FIG. 1 is a block diagram conceptually illustrating an architecture of a computer system including a management server device into which the server management program is installed in the embodiment.

This computer system is equipped with a management server 10, a management target server 20 managed by the management server 10, and a standby server 30. The management target server 20 and the standby server 30 are connected to the Internet via a network switch 40 and also connected to an external storage 42 via an FC (Fiber Channel) switch 41. The management server 10 is connected via a management LAN (Local Area Network) to the management target server 20, the standby server 30, the network switch 40 and the FC switch 41, respectively.

The management server 10 is equipped with a manager 11 configured by software including the server management program in the embodiment.

The management target server 20 has a built-in boot-enabled system disk (hard disk) 21. The system disk 21 is preinstalled with an agent 22 defined as a software component for monitoring a status of the management target server 20 by performing communications with the manager 11 of the management server 10. The standby server 30 has the same hardware configuration as the management target server 20 but the hard disk, which is a diskless configuration.

Unique pieces of IP address (IP1), MAC address (MAC1) and WWPN information (WWPN1) are set in the management target server 20. Similarly, unique pieces of MAC address (MAC2) and WWPN information (WWPN2), which are different from those of the management target server 20, are set in the standby server 30. Note that the system disk 21 of the management target server 20 is recorded with the IP address (IP1) and a server ID (ID1) defined as server identifying information for identifying the server. It should be noted that the MAC address and the WWPN information correspond to interface identifying information for identifying an interface unit for establishing a connection with the network of the management target server.

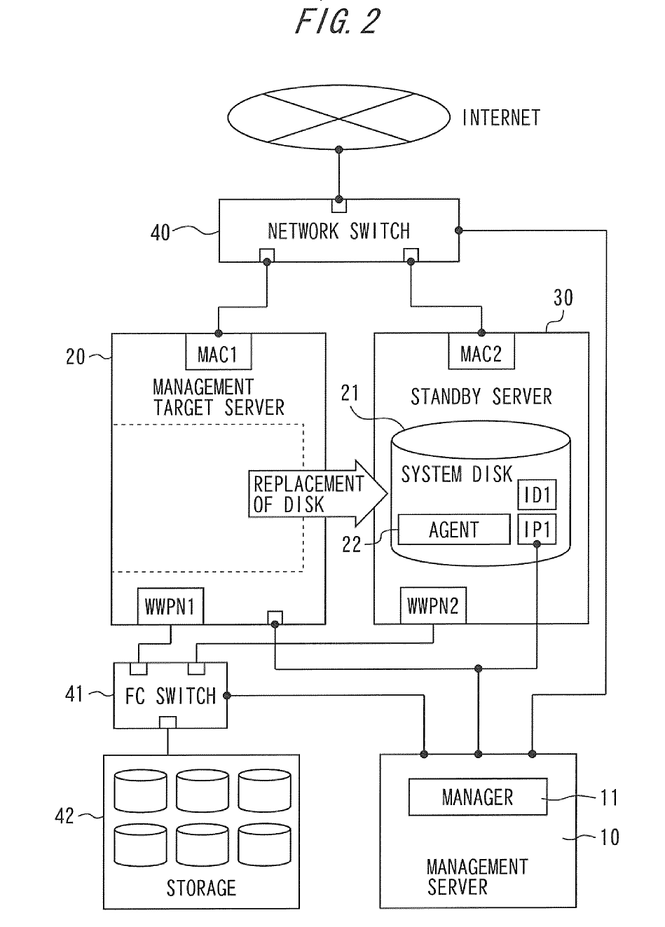

If the management target server 20 gets into a fault during an operation of the system described above and this fault is that related to a component (e.g., the fault of a motherboard) other than the disk, the system disk 21 is removed from the management target server 20 and inserted into the standby server 30 FIG. 2 depicts a status after the system disk 21 has been replaced. The manager 11 of the management server 10, as will be explained later on, updates contents of the server management table for managing information of the management target server, thus obviating mismatching of a network address etc.

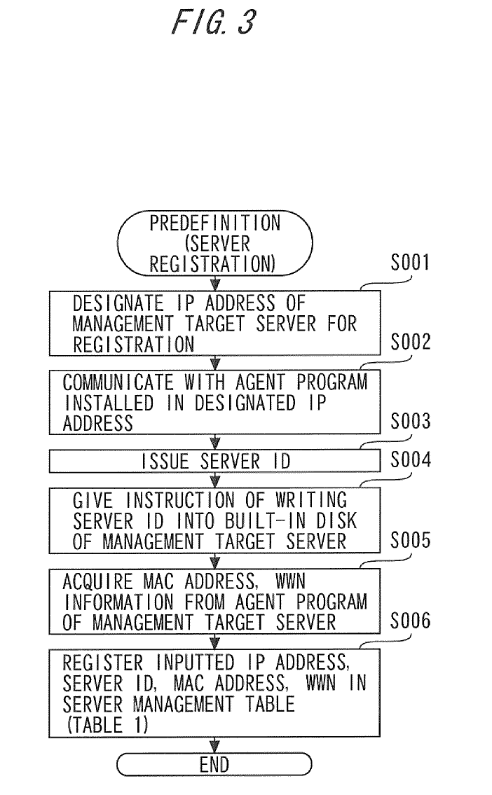

Next, an operation of the manager 11 of the management server 10 in the embodiment, which is configured as described above, will be discussed with reference to flowcharts from FIG. 3 onward. The manager 11 advances the process based on the server management program.

On the occasion of operating the system, the manager 11 executes a predefinition (server registration) process illustrated in FIG. 3 in a status where the management target server 20 normally operates. In this process, the management target server is registered in the management server. In step S001, the IP address of the management target server 20 registered by an administrator is designated. The manager 11 performs the communications with the agent 22 installed into the management target server 20 having the designated IP address in step S002, and instructs the agent 22 to issue a server ID to the management target server 20 as a communication partner in step S003 and further instructs the agent 22 to write the server ID to the built-in disk of the management target server 20 in step S004. The manager 11 executing the step S004 corresponds to server identifying information writing device which allocates server identifying information to the management target server 20 and giving an instruction to write the server identifying information to the system disk of the management target server 20.

Subsequently, the manager 11 requests the agent of the management target server for the IP address, the MAC address and the WWPN information and thus acquires these items of information (S005), then registers the server ID issued in step S003, the items of information acquired in step S005 and “Normal” as status information in a server management table as illustrated in Table 1 (S006), and finishes the predefinition process. The IP address is properly set by the administrator when installing the OS into the management target server 20. The manager 11 executing the process in step S006 corresponds to server registering device which registers server identifying information in the server management table in the way of being associated with interface identifying information transmitted from the management target server.

TABLE 1

| IP address | MAC address | WWPN | Server ID | Status |
|---|---|---|---|---|
| IP1 | MAC1 | WWPN1 | 1 | Normal |

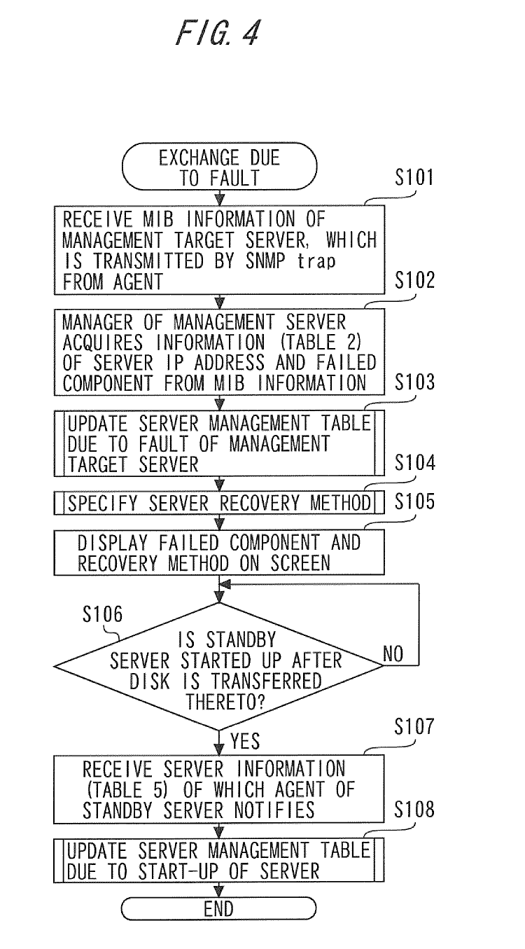

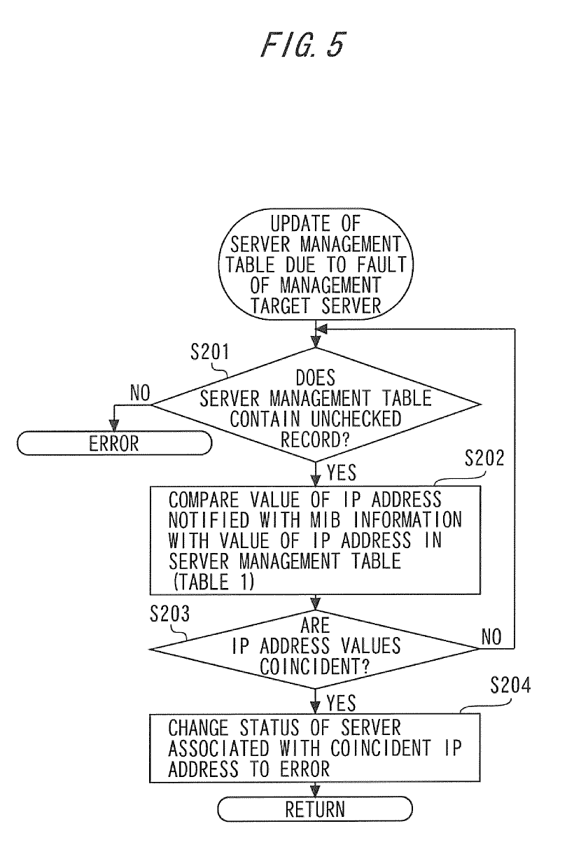

Next, a process on such an occasion that the management target server 20 gets into the fault and is replaced by the standby server 30 will herein after be described with reference to FIG. 4. When the fault occurs in the management target server 20, the agent 22 transmits SNMP (Simple Network Management Protocol) MIB (Management Information Base) information of the management target server by use of SNMP trap, and the manager 11 of the management server 10 receives this information (S101) and acquires the server IP address and information about a failed component illustrated in Table 2 on the basis of the MIB information (S102).

TABLE 2

| IP address | Fault component |
|---|---|
| IP1 | Motherboard |

Subsequently, the manager 11 invokes and executes a subroutine of a server management table updating process in the case of the fault of the management target server in step S103. FIG. 5 illustrates details of this subroutine. The manager 11 on the management server 10, as long as the records in the server management table include an unchecked record (S201, YES), compares a value of the IP address in the Table 2 that is reported through the MIB information with a value of the IP address in the server management table (Table 1) (S202), then if these IP addresses are coincident with each other (S203, YES), rewrites a status of the management target server associated with this coincident IP address into an error status (S204), and loops back to S104 in FIG. 4. As a result of the rewriting, the contents of the server management table are updated as depicted in Table 3 given below.

TABLE 3

| IP address | MAC address | WWPN | Server ID | Status |
|---|---|---|---|---|
| IP1 | MAC1 | WWPN1 | 1 | Error |

If no record containing the coincident IP address is detected (S203, NO) and any unchecked record does not exist (S201, NO), the manager 11 sets this process as resulting in error and loops back to S104 in FIG. 4.

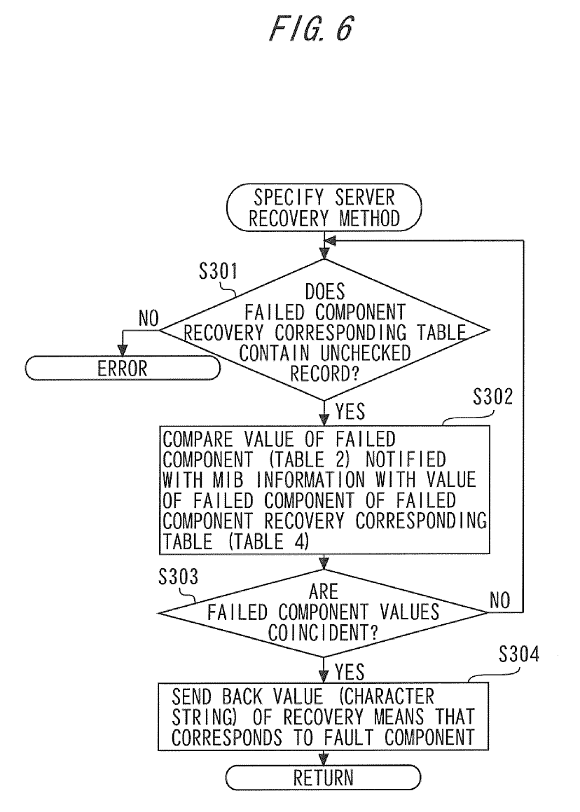

The manager 11, when the process returns from the subroutine in step S103, invokes and executes a subroutine of a specified process of a server recovery method in step S104. FIG. 6 illustrates details of this subroutine. The manager 11 on the management server 10 refers to a failed component recovery associating table depicted in Table 4 in which the failed component is associated with the recovery method, and searches for the recovery method associated with the failed component reported through the MIB information.

TABLE 4

| Failed component | Recovery Method |
|---|---|
| CPU | Replacement of parts |
| Fan | Replacement of parts |
| Motherboard | Replacement of server |
| Disk | Replacement of disk |

To be specific, in the subroutine of FIG. 6, the manager 11, as long as the records in the filed component recovery associating table in Table 4 include any unchecked record (S301, YES), compares the failed component in Table 2 that is reported through the MIB information with the failed component in the fault component recovery associating table (Table 4) (S302), then, if the fault components are coincident with each other (S303, YES), extracts a value (character string) of the recovery method associated with the coincident failed component (S304) and loops back to S105 in FIG. 4.

If no record containing the coincident failed component is detected (S303, NO) and any unchecked record does not exist (S301, NO), the manager 11 sets this process as resulting in error and loops back to S105 in FIG. 4

In step S105, the manager 11 notifies the administrator of the failed component and the recovery method that are specified in the subroutine by displaying the failed component and the recovery method on a screen of the management server 10. Herein, the information about parts should be replaced corresponding to the recovery method is presented to the administrator. If the recovery method indicates replacement of the server, the manager 11 presents a purport that the recovery can be attained by reinserting the built-in disk into the standby server. The manager 11 executing the process in step S105 corresponds to recovery method presenting device which presents the recovery method associated with the failed component to the administrator.

In step S106, the administrator reinserts the built-in system disk of the management target server into the standby server and stands by till the standby server is started up, and the manager 11 in step S107, when the standby server is started up, receives the server information as illustrated in Table 5, which is transmitted from the agent of the standby server after being started up. The manager 11 executing the process in step S107 corresponds to identifying information acquiring device acquiring the server identifying information and the interface identifying information, which are transmitted from the standby server.

TABLE 5

| IP address | MAC address | WWPN | Server ID |
|---|---|---|---|
| IP1 | MAC2 | WWPN2 | 1 |

Subsequently, in step S108, the manager 11 invokes and executes a subroutine of a server management table updating process when the server is started up, and terminates the replacement process due to the fault.

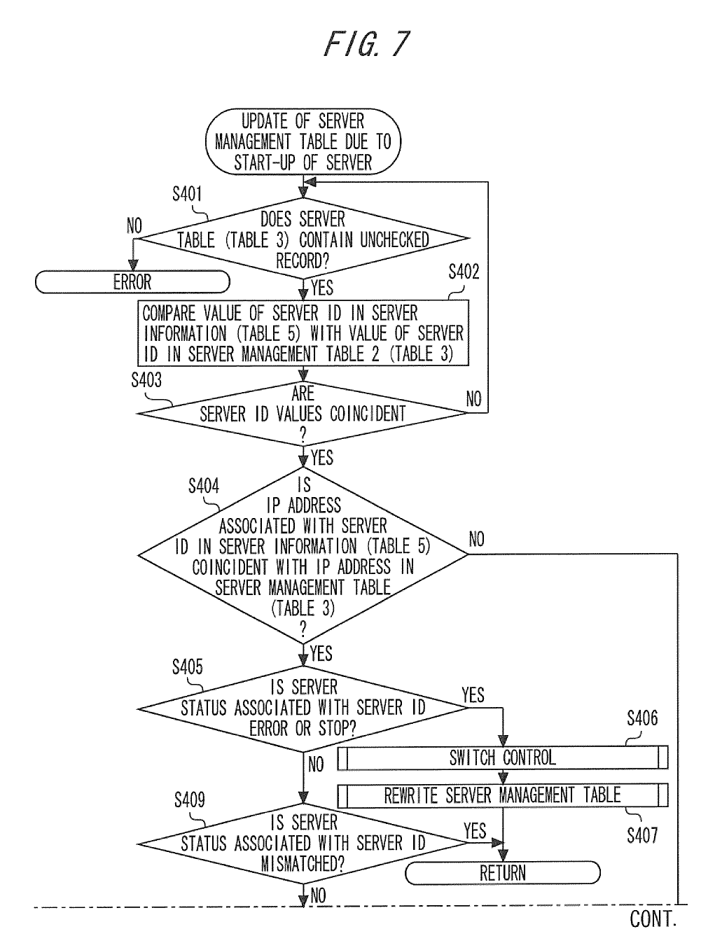

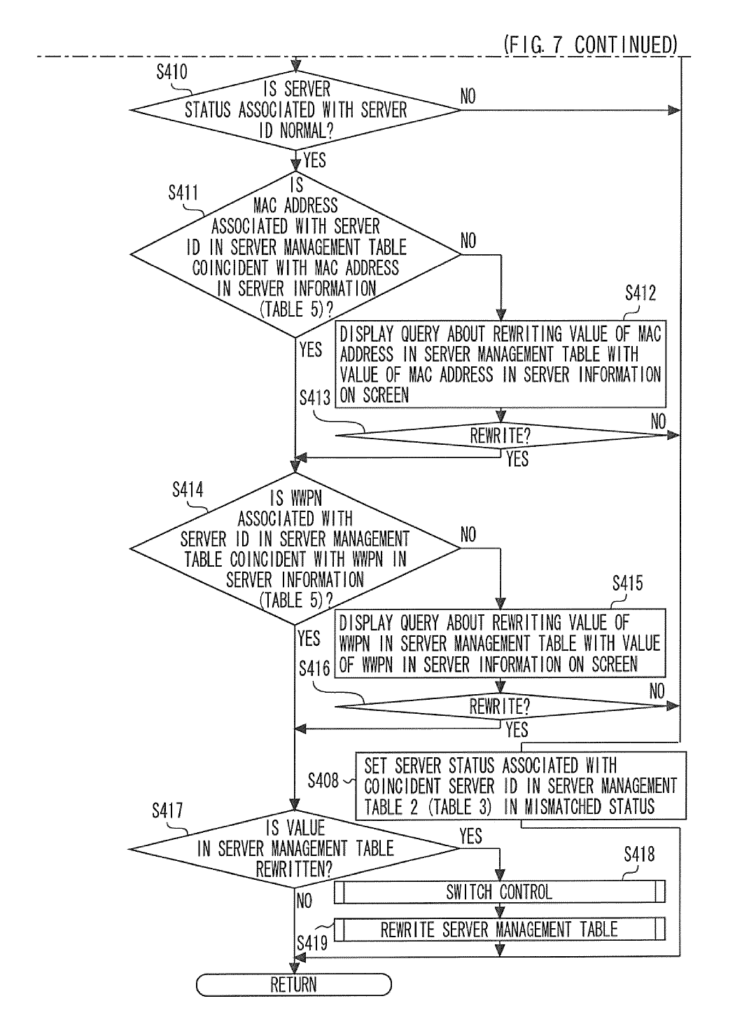

FIG. 7 illustrates details of the subroutine of the server management table updating process when the server is started up. In this subroutine, the manager 11 on the management server 10, as long as the records in the server management table depicted in Table 3 include any unchecked record (S401, YES), searches through the server management table illustrated in Table 3 in a way that uses a value of the server ID of the server information illustrated in Table 5 as a key (search key) (S402). In the case the server ID (S403, YES) is correspondent with that in Table 3, the manager 11, if the IP address in the server information (Table 5) associated with the server ID is coincident with the IP address in the server management table (Table 3) (S404, YES), checks the status of the management target server associated with the coincident server ID, then, in the case of an error or a stop (S405, YES), executes a switch control process in step S406 and a subroutine of a server management table rewriting process in step S407 respectively, and returns to FIG. 4. Details of these subroutines will be described later on. The manager 11 executing the process in each of steps S402, S403 corresponds to extracting device which extracts a record with the server identifying information coincident with the server identifying information (Table 5) acquired by the identifying information acquiring device, out of the records registered in the server management table (Table 3).

If no record containing the coincident server ID is detected (S403, NO) and no unchecked record exists (S401, NO), the manager 11 sets this process as resulting in error and loops back to FIG. 4. Further, the manager 11, when determining that the IP addresses are not coincident with each other with respect to the coincident server ID, notifies the administrator of this purport, then, rewrites the status of the management target server associated with the coincident server ID in the server management table in Table 3 into “Mismatching” in step S408, and loops back to the process in FIG. 4. As a result of the rewriting, the contents of the server management table are updated as illustrated in Table 6 given below. Hereafter, the status of the management target server remains mismatching till a recovery process of the server in a mismatching status that will be explained later on is carried out.

TABLE 6

| IP address | MAC address | WWPN | Server ID | Status |
|---|---|---|---|---|
| IP2 | MAC2 | WWPN2 | 1 | Mismatching |

On the other hand, if the status of the server associated with the coincident server ID is determined to be neither the error nor the stop in step S405, the manager 11 decides in step S409 whether the server status is the mismatching status or not. Then, in the case of the mismatching status, the manager 11 executes nothing and loops back to the process in FIG. 4. Whereas if not the mismatching status, the manager 11 advances the process to next step S410.

In step S410, the manager 11 determines whether the status of the management target server associated with the coincident server ID is normal or not, then, if not normal, sets the status into the mismatching status in step S408, and returns to the process in FIG. 4. Whereas if normal, the manager 11 advances to step S411.

In step S411, the manager 11 decides whether or not the MAC address in the server management table (Table 2) that is associated with the coincident server ID is coincident with the MAC address in the server information (Table 5), and, if not coincident, displays on a screen a purport of whether a value of the MAC address in the server management table may be rewritten with a value of the MAC address in the server information in step S412, thus prompting the administrator to make a selection. If the administrator does not give a rewriting instruction (S413, NO), the manager 11 sets the status into the mismatching status in step S408, then loops back to the process in FIG. 4, whereas if the rewriting instruction is given (S413, YES), advances to step S414.

In step S414, the manager 11 decides whether or not the WWPN address in the server management table (Table 2) that is associated with the coincident server ID is coincident with the WWPN address in the server information (Table 5), and, if not coincident, displays on the screen a purport of whether a value of the WWPN address in the server management table may be rewritten with a value of the WWPN address in the server information in step S415, thus prompting the administrator to make a selection. If the administrator does not give the rewriting instruction (S416, NO), the manager 11 sets the status into the mismatching status in step S408, then loops back to the process in FIG. 4, whereas if the rewriting instruction is given (S416, YES), advances to step S417.

In step S417, the manager 11 determines in steps S413, S416 whether the instruction to rewrite the server management table is given or not, then, if instructed (S417, YES), executes the switch control process in step S406 and a subroutine of the server management table rewriting process in step S407 respectively, and returns to FIG. 4. Whereas if the rewriting instruction is not given, the manager 11 returns directly to FIG. 4.

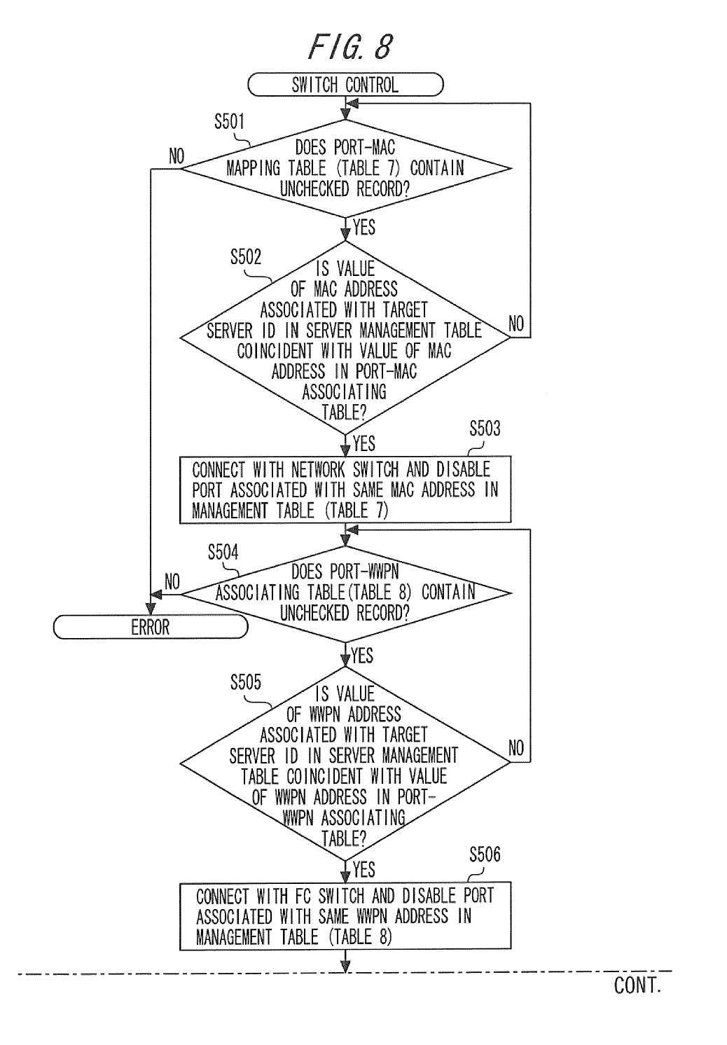

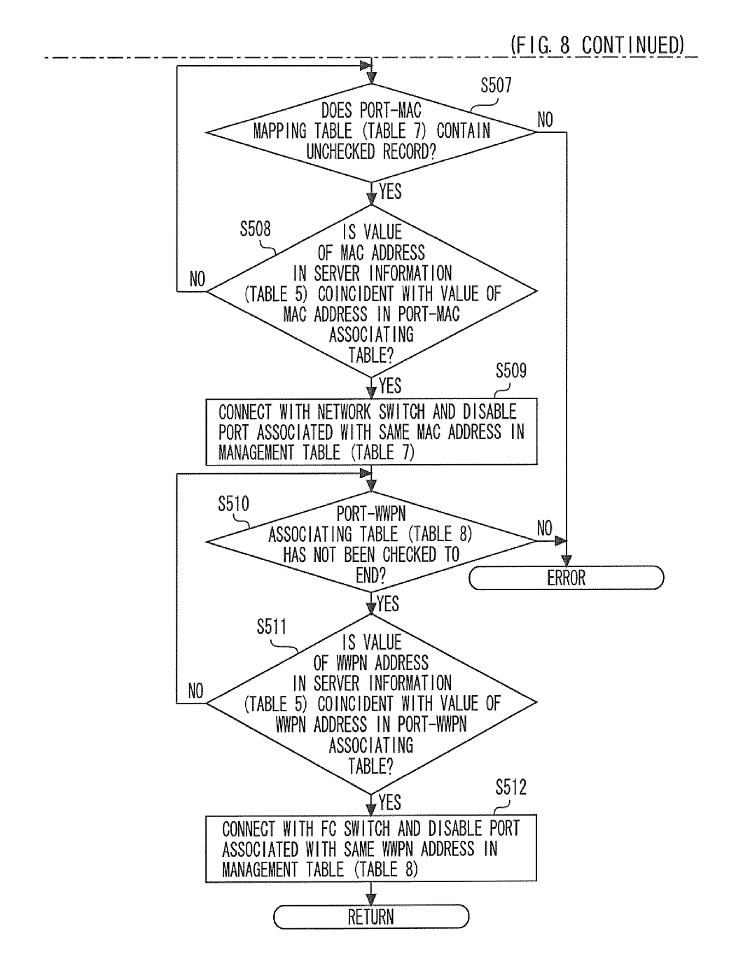

Subsequently, details of a subroutine of the switch control process invoked in steps S406, S418 in FIG. 7 will hereinafter be described with reference to FIG. 8. A first half of the subroutine in FIG. 8 corresponds to a process of closing a port of the management target server getting into the fault, while the second half corresponds to a process of opening the port of the standby server.

In the switch control process, the manager 11 of the management server 10 refers to a port-MAC associating table (illustrated in Table 7 given below) stored in the network switch 40 and a port-WWPN associating table (illustrated in Table 8 given below) stored in the FC switch 41, and manipulates values in these tables.

TABLE 7

| Port number | MAC address | Status |
|---|---|---|
| 1 | MAC1 | Enable |
| 2 | MAC2 | Enable |
| . | . | . |
| . | . | . |
| . | . | . |

TABLE 8

| Port number | WWPN address | Status |
|---|---|---|
| 1 | WWPN 1 | Enable |
| 2 | WWPN 2 | Enable |
| . | . | . |
| . | . | . |
| . | . | . |

The manager 11, as long as the records in the port-MAC associating table depicted in Table 7 include any unchecked record (S501, YES), determines whether or not the MAC address associated with the target server ID (the server ID determined to be coincident in step S403 of FIG. 7) in the server management table depicted in Table 3 is coincident with the MAC address in the port-MAC associating table illustrated in Table 7 (S502). If these MAC addresses are coincident with each other (S502, YES), the manager 11 establishes a connection with the network switch 40 in step S503, then sets the status of the port associated with the same MAC address in the port-MAC associating table as “Disable”, and closes the port.

If no record containing the coincident MAC address is detected (S502, NO) and any unchecked record exists (S501, NO), the manager 11 sets this process resulting in error and loops back to S407 in FIG. 7.

If the coincident MAC address exists, subsequently, the manager 11, as long as the records in the port-WWPN associating table illustrated in FIG. 8 include any unchecked record (S504, YES), determines whether or not the WWPN address associated with the target server ID in the server management table depicted in Table 3 is coincident with the WWPN address in the port-WWPN associating table illustrated in Table 8 (S505). If these WWPN addresses are coincident with each other (S505, YES), the manager 11 establishes a connection with the FC switch 41 in step S506, then sets the status of the port associated with the same WWPN address in the port-WWPN associating table as “Disable”, and closes the port.

If no record containing the coincident WWPN address is detected (S505, NO) and no unchecked record exists (S504, NO), the manager 11 sets this process resulting in error and loops back to S407 in FIG. 7.

Next, the manager 11, as long as the records in the port-MAC associating table depicted in Table 7 include any unchecked record (S507, YES), determines whether or not the MAC address in the server information illustrated in Table 5 is coincident with the MAC address in the port-MAC associating table illustrated in Table 7 (S508). If these MAC addresses are coincident with each other (S508, YES), the manager 11 establishes a connection with the network switch 40 in step S509, then sets the status of the port associated with the same MAC address in the port-MAC associating table as “Enable”, and opens the port.

If no record containing the coincident MAC address is detected (S508, NO) and no unchecked record exists (S507, NO), the manager 11 sets this process as resulting in error and loops back to S407 in FIG. 7.

If the coincident MAC address exists, subsequently, the manager 11, as long as the records in the port-WWPN associating table illustrated in FIG. 8 include any unchecked record (S510, YES), determines whether or not the WWPN address in the server information illustrated in table 5 is coincident with the WWPN address in the port-WWPN associating table illustrated in Table 8 (S511) If these WWPN addresses are coincident with each other (S511, YES), the manager 11 establishes a connection with the FC switch 41 in step S512, then sets the status of the port associated with the same WWPN address in the port-WWPN associating table as “Enable”, and opens the port.

If no record containing the coincident WWPN address is detected (S511, NO) and no unchecked record exists (S510, NO), the manager 11 sets this process as resulting in error and loops back to S407 in FIG. 7.

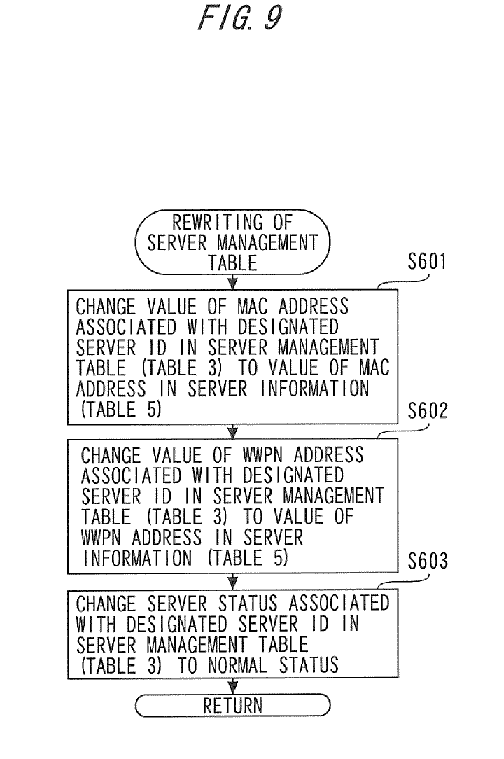

Next, details of a subroutine of a server management table rewriting process invoked in steps S407, S419 in FIG. 7 will hereinafter be described with reference to FIG. 9. In this subroutine, the manager 11 changes a value of the MAC address and a value of the WWPN address, which are associated with the designated server ID in the server management table (Table 3), into the values in the server information (Table 5) (S601, S602), and also changes the status of the server having this server ID into “Normal” (S603). Through this operation, the manager 11 determines that the server recovery is attained by the replacement of the disk, and thereafter manages the standby server as a new management target server. The manager 11 executing the process in each of steps S601, S602 corresponds to rewriting device which rewrites a value of the interface identifying information in the extracted record in the server management table (Table 3) with a value of the interface identifying information (Table 5) acquired by the identifying information acquiring device.

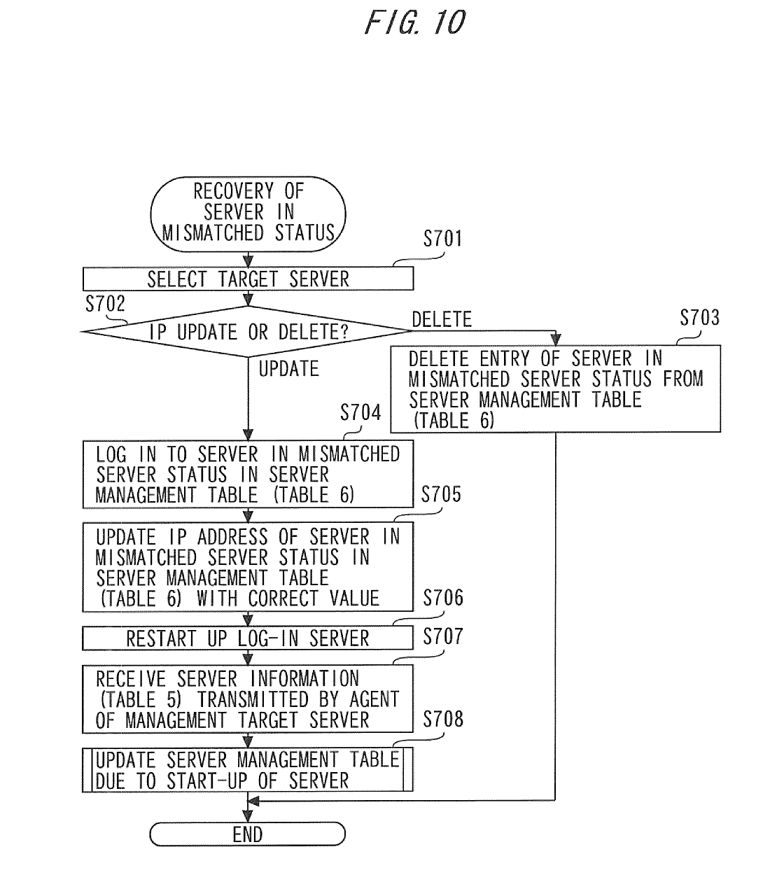

Next, a process for recovering the server set in the mismatching status in step S408 of FIG. 7 will be described with reference to FIG. 10. This process is executed, when the server management table is displayed by the administrator on an unillustrated screen of the management server 10 and there is mismatching.

In first step S701 in FIG. 10, the manager 11 of the management server 10 displays the screen for prompting the administrator to select the recovery target server. If a plurality of servers taking the mismatching status exists, one of these servers is herein selected. Next, the administrator is requested to select the recovery method such as that by updating the IP address and that by deleting the entry. If that by deleting is selected, the manager 11 deletes the entry of the target server taking the mismatching status from the server management table (Table 6) in step S703, and finishes the process.

On the other hand, if that by updating is selected, the manager 11 logs in to the target server for which “Mismatching” is registered in the server management table (Table 6) (S704), then updates the IP address of the server with a valid value inputted by the administrator (S705), and restarts up the server (S706). The agent 22 of the started-up management target server transmits the server information (Table 5), and hence the manager 11 receives the server information in step S707, executes the server management table updating process when the server is started up as illustrated in FIG. 7 and terminates the process. This operation obviates the mismatching status, and therefore the server may be registered as the management target server in the predefinition process depicted in FIG. 3.

Note that there is a case that the disk is transferred not only when the fault occurs as described above but also by an intention of the administrator for preventive maintenance. In this case, the administrator shuts down the management target server and transfers the disk into the standby server, thus starting up the standby server. The management target server, when shut down, notifies the management server of a status illustrated in Table 9 given below.

TABLE 9

| IP address | Status |
|---|---|
| IP1 | Stop |

The manager 11 of the management server 10 updates the server management table on the basis of the received status notification.

TABLE 10

| IP address | MAC address | WWPN | Server ID | Status |
|---|---|---|---|---|
| IP1 | MAC1 | WWPN1 | 1 | Stop |

The process described above is substantially the same as the change of the server management table due to the fault of the management target server illustrated in FIG. 5, and a difference is only such a point that the status set in step is not “Error” but “Stop.” The operation other than this point is the same as from step S106 onward in the replacement process due to the fault illustrated in FIG. 4.

What is claimed is:

1. A computer readable medium stored with a server management program making a management server computer, which manages a management target server having a built-in system disk with which the server can be booted and a standby server disposed as a substitute device for said management target server via a network, function as:
a server identifying information writing device instructing said management target server to write server identifying information to the system disk of said management target server;
a server registering device registering the server identifying information in the server management table in a way that associates the server identifying information with interface identifying information, transmitted from said management target server, for identifying an interface unit of said management target server for a connection with a network;
an identifying information acquiring device acquiring, after an administrator has started up a standby server by reinserting a system disk of said management target server into said standby server, the server identifying information and the interface identifying information transmitted from said standby server;
an extracting device extracting from records registered in the server management table, a record in which the server identifying information is coincident with the server identifying information acquired by said identifying information acquiring device; and
a rewriting device of rewriting a value of the interface identifying information in the record, extracted by said extracting device, in the server management table with a value of the interface identifying information acquired by said identifying information acquiring device.

2. A computer readable medium according to claim 1, wherein
the server registering device registers the information including an operating status of the management target server in the server management table, and updates the operating status based on the information given from the management target server, and
the extracting device, when the operating status in the record containing the server identifying information coincident with that acquired by the identifying information acquiring device is not “normal”, extracts this record.

3. A computer readable medium according to claim 1 said program further making the management server computer function as recovery method presenting device searching through, if a fault occurs in the management target server, a fault component recovery associating table in which a fault component and a recovery method are previously registered in the way of being associated with each other on the basis of information on the fault component that is sent from the management target server, and presenting the recovery method associated with the fault component to the administrator.

4. A server management method of managing a management target server having a built-in system disk with which the server can be booted and a standby server disposed as a substitute device for the management target server via a network, a server management computer executing:
a server identifying information writing step of instructing the management target server to write server identifying information to the system disk of the management target server;
a server registering step of registering the server identifying information in the server management table in a way that associates the server identifying information with interface identifying information, transmitted from the management target server, for identifying an interface unit of the management target server for a connection with a network;
an identifying information acquiring step of acquiring, after an administrator has started up a standby server by reinserting a system disk of the management target server into the standby server, the server identifying information and the interface identifying information transmitted from the standby server;
an extracting step of extracting from records registered in the server management table, a record in which the server identifying information is coincident with the server identifying information acquired in the identifying information acquiring step; and
a rewriting step of rewriting a value of the interface identifying information in the record, extracted in the extracting step, in the server management table with a value of the interface identifying information acquired in the identifying information acquiring step.

5. A server management method according to claim 4, wherein the server registering step includes registering an operating status of the management target server in the server management table and updates the operating status based on the information given from the management target server, and
the extracting step includes, when the operating status in the record containing the server identifying information coincident with that acquired by the identifying information acquiring device is not “normal” extracting this record.

6. A server management method according to claim 4, wherein the management server computer further executes a recovery method presenting step of searching through, if a fault occurs in the management target server, a fault component recovery associating table in which a fault component and a recovery method are previously registered in the way of being associated with each other on the basis of information on the fault component that is sent from the management target server, and presenting the recovery method associated with the fault component to the administrator.

7. A server management device which manages a management target server having a built-in system disk with which the server can be booted and a standby server disposed as a substitute device for the management target server via a network, comprising:
server identifying information writing device instructing the management target server to write server identifying information to the system disk of the management target server;
server registering device registering the server identifying information in the server management table in a way that associates the server identifying information with interface identifying information, transmitted from the management target server, for identifying an interface unit of the management target server for a connection with a network;
identifying information acquiring device acquiring, after an administrator has started up a standby server by reinserting a system disk of the management target server into the standby server, the server identifying information and the interface identifying information transmitted from the standby server;
extracting device extracting from records registered in the server management table, a record in which the server identifying information is coincident with the server identifying information acquired by the identifying information acquiring device; and
rewriting device of rewriting a value of the interface identifying information in the record, extracted by the extracting device, in the server management table with a value of the interface identifying information acquired by the identifying information acquiring device.

8. A server management device according to claim 7, wherein the server registering device registers the information including an operating status of the management target server in the server management table, and updates the operating status based on the information given from the management target server, and
the extracting device, when the operating status in the record containing the server identifying information coincident with that acquired by the identifying information acquiring device is not “normal”, extracts this record.

9. A server management device according to claim 7, further comprising recovery method presenting device searching through, if a fault occurs in the management target server, a fault component recovery associating table in which a fault component and a recovery method are previously registered in the way of being associated with each other on the basis of information on the fault component that is sent from the management target server, and presenting the recovery method associated with the fault component to the administrator.
